(19) United States
(12) Patent Application Publication
(10) Pub. No.: US 2014/0191943 A1
(43) Pub. Date: Jul. 10, 2014

(54) ELECTRONIC APPARATUS AND METHOD FOR CONTROLLING ELECTRONIC APPARATUS THEREOF

(71) Applicant: SAMSUNG ELECTRONICS CO., LTD., Suwon-si (KR)

(72) Inventors: Dong-heon LEE, Seoul (KR); Jung-geun KIM, Suwon-si (KR); Sung-hyun JANG, Seoul (KR); Jae-kwon KIM, Suwon-si (KR)

(73) Assignee: SAMSUNG ELECTRONICS CO., LTD., Suwon-si (KR)

(21) Appl. No.: 14/133,769

(22) Filed: Dec. 19, 2013

(30) Foreign Application Priority Data
Jan. 7, 2013 (KR) 10-2013-0001799

(51) Int. Cl. G06F 3/01

(52) U.S. Cl. CPC G06F 3/017
USPC 345/156

(57) ABSTRACT

An electronic apparatus is provided. The electronic apparatus includes a motion input unit configured to receive a user motion, a display configured to display an object controlled by the user motion received by the motion input unit, and a controller configured to change a display state of the object in response to the input user motion satisfying a predetermined condition with respect to a motion recognition scope.

### CROSS-REFERENCE TO RELATED APPLICATIONS

This application claims priority from Korean Patent Application No. 10-2013-1799, filed in the Korean Intellectual Property Office on Jan. 7, 2013, the disclosure of which is incorporated herein by reference in its entirety.

### BACKGROUND

1. Field

Apparatuses and methods consistent with exemplary embodiments relate to an electronic apparatus and a method for controlling an electronic apparatus thereof, and more particularly, to an electronic apparatus which is controlled by an input user motion and a method for controlling an electronic apparatus thereof.

2. Description of the Related Art

With the development of electronic technology, various types of display apparatuses have been developed. Further, various types of display apparatuses, including, e.g., a television, have been used in general households. Such display apparatuses are providing more and more functions in accordance with users' increasing needs. For example, a television may be connected to the Internet, and may even provide Internet services. In addition, a user may watch a plurality of digital broadcasting channels through a television.

Accordingly, various input methods are implemented to use various functions of a display apparatus effectively. For example, various input methods may include using a remote controller, a mouse, or a touch pad that may be communicably coupled to an electronic apparatus.

However, there are a number of considerations that may be contemplated when utilizing various functions of a display apparatus with such a simple input method.

For example, when all of the functions of a display apparatus are controlled by a remote controller, it may lead to increasing the number of buttons on the remote controller. In this case, it may not be easy for a general user to get familiar with the method for using such a remote controller to perform a requested function. Similarly, when various menus are displayed on the screen for a user who then searches and selects through each and every menu, the user may be burdened with the need to check all of the complicated menu trees in order to find a desired menu in order to perform a requested function, causing inconvenience to the user.

In order to address the considerations discussed above, motion recognition technology, which allows a user to control an electronic apparatus more conveniently and intuitively, has been developed. That is, the technology of controlling an electronic apparatus by recognizing a user motion has come into the spotlight in recent days.

However, according to the related motion recognition technology art, a user may not be aware of various issues which may occur due to the limitation of a sensor that recognizes a user motion in advance.

### SUMMARY

One or more exemplary embodiments provide an electronic apparatus that may inform a user of possible issues that may occur due to the limitation in the recognition scope of a sensor recognizing a user motion in advance, and a method for controlling an electronic apparatus thereof.

According to an aspect of an exemplary embodiment, there is provided an electronic apparatus including a motion input unit configured to receive a user motion, a display configured to display an object controlled by the user motion received by the motion input unit, and a controller configured to change a display state of the object in response to the input user motion satisfying a predetermined condition with respect to a motion recognition scope.

The controller may be further configured to change at least one of a color, a transparency, and a shape of the object displayed by the display in response to the user motion entering into an area within a scope of a recognition limit, and the area is predetermined to be inside the motion recognition scope with respect to a border of the motion recognition scope.

The controller may be further configured to increase a transparency of the object displayed by the display in response to the input user motion moving in a direction closer to the border of the motion recognition scope within the scope of the recognition limit.

The controller may be further configured to remove the object from being displayed by the display in response to the input user motion going beyond the motion recognition scope.

The electronic apparatus may further include an audio output unit, and the controller may be further configured to control the audio output unit to output an alarm sound in response to the user motion being within a scope of a recognition limit which is predetermined to be an area inside the motion recognition scope with reference to the motion recognition scope.

The controller may be further configured to change a motion speed of the object displayed by the display in response to the object moving in a predetermined area of the display according to the user motion.

The controller may be further configured to decrease the motion speed of the object displayed by the display at a predetermined peripheral area of the display.

The motion input unit may be configured to include a camera photographing the user motion, and the motion recognition scope of the motion input unit may be changed according to an angle of the camera.

According to an aspect of another exemplary embodiment, there is provided a method for controlling an electronic apparatus, the method including displaying an object controlled by a user motion on a display, and changing a display state of the object displayed on the display in response to the user motion satisfying a predetermined spatial condition with respect to a motion recognition scope.

The changing of the display state and the object may include, changing at least one of a color, a transparency, and a shape of the object displayed on the display in response to the user motion entering into an area within a scope of recognition limit which is predetermined to be an area inside the motion recognition scope with respect to a border of the motion recognition scope.

The changing of the display state and the object may include, increasing a transparency of the object displayed on the display in response to the input user motion moving in a direction closer to a border of the motion recognition scope within the scope of a recognition limit.

The method may further include, removing the object from being displayed on the display in response to the user motion going beyond the motion recognition scope.

The method may further include, outputting an alarm sound in response to the user motion being input within a scope of a recognition limit which is predetermined to be an area inside the motion recognition scope.

The method may further include, changing a motion speed of the object displayed on the display in response to the object moving in a predetermined area of the display according to the user motion.

The changing a motion speed of the object may further include decreasing the motion speed of the object displayed on the display at a predetermined peripheral area of the display.

Herein, the motion recognition scope may be a photographing scope which is changed according to an angle of a camera photographing the user motion.

### BRIEF DESCRIPTION OF DRAWINGS

The above and other aspects will be more apparent by describing certain exemplary embodiments with reference to the accompanying drawings, in which:

FIG. 1 is a schematic view illustrating an electronic apparatus according to an exemplary embodiment;

FIG. 2 is a block diagram illustrating a configuration of an electronic apparatus according to an exemplary embodiment;

FIG. 3 is a block diagram illustrating a configuration of an electronic apparatus according to an exemplary embodiment;

FIG. 4 is a block diagram illustrating a configuration of software stored in a storage according to an exemplary embodiment;

FIGS. 5A through 5D are views illustrating a method for providing a User Interface (UI) according to an exemplary embodiment;

FIGS. 6A and 6B are a views illustrating a method for providing a UI according to an exemplary embodiment; and

FIG. 7 is a flowchart illustrating a method for controlling an electronic apparatus according to an exemplary embodiment.

### DETAILED DESCRIPTION

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail because they would obscure the application with unnecessary detail.

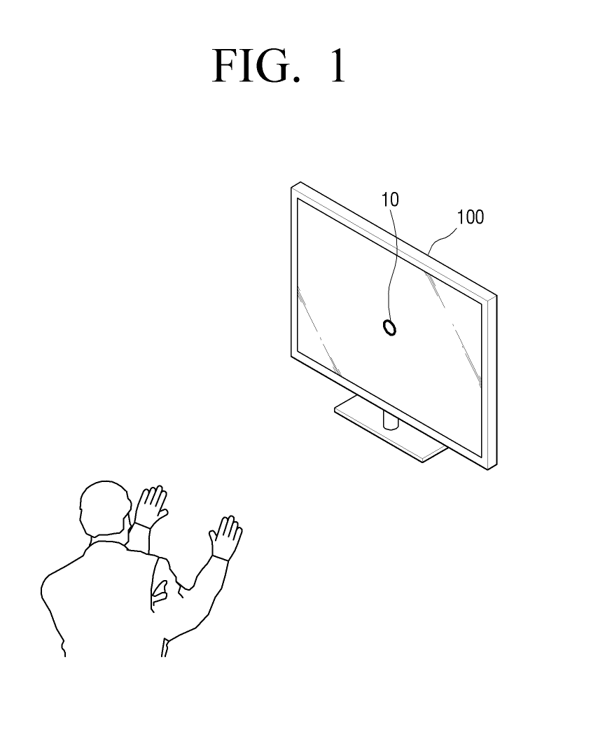

FIG. 1 is a schematic view illustrating an electronic apparatus according to an exemplary embodiment.

An electronic apparatus 100 may sense a user motion, and may be realized as a digital television which may be controlled by the sensed motion. However, the electronic apparatus 100 may be realized as any apparatus which may be capable of recognizing a user motion, such as a PC monitor.

Once a user motion is sensed, the electronic apparatus 100 may generate motion information according to the sensed motion, change the generated motion information to a control signal to control the electronic apparatus 100, and then perform a function based on the control signal.

In particular, the electronic apparatus 100 may display an object which may be controlled by a user motion, for example, a pointer 10, and may control the motion state of the pointer 10 based on an input user motion.

In addition, the electronic apparatus 100 may change the display state of a displayed pointer 10 based on a recognition scope of a sensor which recognizes a user motion. For example, the display state of the pointer may be changed in response to a user motion being recognized at a border of the recognition scope of a sensor. Further, the recognition scope of the sensor may be a photographing scope determined by the angle of a camera in response to the sensor being realized as a camera.

The specific operations of the electronic apparatus 100 may be explained with reference to drawings.

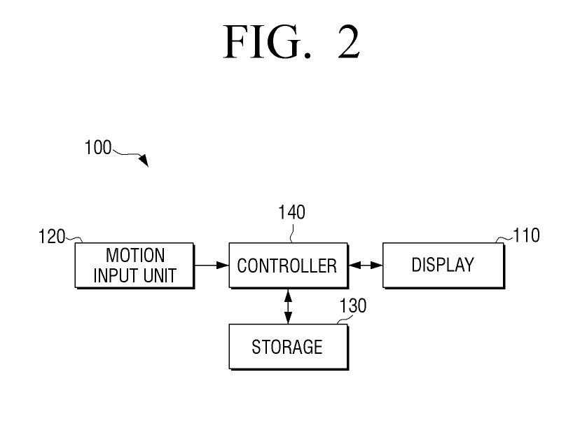

FIG. 2 is a block diagram illustrating a configuration of the electronic apparatus 100 according to an exemplary embodiment. Additionally, referring specifically to the block diagram of FIG. 2, it can be appreciated that the electronic apparatus 100 may include a display 110, a motion input unit 120, a storage 130, i.e., memory and a controller 140. The electronic apparatus 100 may be a smart television, but this is only an example. The electronic apparatus 100 may be realized as various electronic apparatuses such as a smart phone, a tablet PC, a notebook PC, etc.

The display 110 displays an image signal that may be input from various sources. For example, the display 110 may display an image corresponding to a broadcast signal received through a broadcast receiver. In addition, the display 110 may display image data (for example, video) input through an external terminal input unit (not shown).

Further, the display 110 may display a UI screen corresponding to a motion task mode. For example, the display 110 may display a screen including an object which is controlled by a motion in the motion task mode, for example, a pointer. Herein, the pointer may be a circular GUI.

The motion input unit 120 receives an image signal (e.g., successive frames) photographing a user motion and provides the image signal to the controller 140. For example, the motion input unit 120 may be realized as a camera unit consisting of a lens and an image sensor. Alternatively, in accordance with one or more exemplary embodiments, the motion input unit may be realized as at least one of an acoustic, inertial, LED, magnetic, or reflective motion tracking system, or combinations thereof. Additionally, the motion input unit may specifically be any one of the following optical motion tracking systems including but not limited to an optical system utilizing image sensors such as a passive optical system that uses markers coated with a retro reflective material to reflect light, an active optical system using illuminating LEDs, a time modulated active system utilizing over-time tracking and a strobing optical marker, and a semi-passive marker system such as a reflective infra-red pattern system. Further, the motion input unit may be a non-optical system such as an inertial system that uses inertial sensors, a mechanical motion capture system such as an exo-skeleton motion capture system, and a magnetic capture system or combination thereof. In addition, the motion input unit 120 may be formed integrally with the electronic apparatus 100 or separately from the electronic apparatus 100. When the motion input unit 120 is provided separately from the electronic apparatus 100, the motion input unit 120 may be communicably connected to the electronic apparatus 100 via a cable or wirelessly.

The storage 130, i.e., memory, stores various data and programs to drive and control the electronic apparatus 100. The storage 130 stores a motion recognition module to recognize a motion input through the motion input unit 120.

In addition, the storage 130 may include a motion database. In this case, the motion database refers to a database where a predetermined motion, and a motion task that is associated with the predetermined motion, are recorded.

The controller 140 controls the display 110, the motion input unit 120, and the storage 130. The controller may include a Central Processing Unit (CPU), and Read Only Memory (ROM) and Random Access Memory (RAM) which store modules and data to control the electronic apparatus 100.

Once the motion received by the electronic apparatus 100 is converted to a motion task mode, the controller 140 may display a pointer to perform a motion task function at a specific location of the display screen (for example, at the center of the screen).

In addition, if a motion is input through the motion input unit 120, the controller 140 recognizes the motion using a motion sensing module and motion database. The motion recognition may be performed by dividing an image corresponding to the user motion input through the motion input unit 120 (for example, successive frames) into a background area and a hand area (for example, an area where a hand is open or clenched) and recognizing the successive movement of the hand using the motion recognition module. If a user motion is input, the controller 140 stores the received image by frame unit, and senses the object of the user motion (for example, a user hand) using the stored frames. The controller 140 detects the object by sensing at least one of a shape, a color, and a movement of the object included in the frames. The controller 140 may trace the movement of the detected object using the location of each object included in a plurality of frames.

The controller 140 determines a user motion according to the shape and movement of a traced object, e.g., the user's hand. For example, the controller 140 determines a user motion using at least one of a change in the shape of the object, speed of the object, location of the object, and direction of the object. Particularly, the user motion includes a ‘grab’ motion which is the motion of clenching a hand, a ‘pointing move’ motion which is the motion of moving a displayed cursor using a hand, a ‘slap’ motion which is the motion of moving a hand in one direction at a speed that is higher than a certain threshold speed, a ‘shake’ motion which is the motion of shaking a hand left/right or up/down, and a ‘rotate’ motion which is the motion of rotating a hand. However, the technical feature of one or more exemplary embodiments may also be applied to other motions than the above-described motions. For example, the user motion may further include a ‘spread’ motion which is the motion of spreading a clenched hand.

In order to determine whether a user motion is a ‘pointing move’ or a ‘slap’, the controller 140 determines whether an object moves beyond a predetermined area, e.g., a square of 40 cm×40 cm, within a predetermined time, e.g., 800 ms. If the object does not go beyond the predetermined area within the predetermined time, the controller 140 may determine that the user motion is a ‘pointing move’ motion. Alternatively, if the object does go beyond the predetermined area within the predetermined time, the controller 140 may determine that the user motion is a ‘slap’ motion. In another example, if it is determined that the speed of an object is below a predetermined speed (for example, 30 cm/s), the controller 140 may determine that the user motion is a ‘pointing move’ motion. If it is determined that the speed of the object exceeds the predetermined speed, the controller 140 determines that the user motion is a ‘slap’ motion.

In response to a user motion satisfying a predetermined condition based on a motion recognition scope from the motion input unit 120, the controller 140 may change the display state of a pointer displayed on a screen. The display state of the pointer may include at least one of a color, a transparency, and a shape of the pointer, but is not limited thereto.

In response to the motion input unit 120 including a camera photographing a user motion as described above, the motion recognition scope from the motion input unit 120 may be a photographing scope determined by the angle of the camera. Accordingly, the motion recognition scope may vary according to the angle of a camera.

Specifically, when a user motion enters into an area within a scope of a recognition limit which is predetermined to be an area inside the motion recognition scope with reference to the border of the scope, the controller 140 may change the display state of the pointer. For example, when a user motion enters into an area within a predetermined scope near the border of the angle scope of a camera, the controller 140 may increase the transparency of the pointer and display the adjusted pointer.

In addition, as an input user motion moves closer in a direction of the border of a motion recognition scope within the scope of a recognition limit, the controller 140 may increase the transparency of the pointer and display the adjusted pointer. For example, the controller 140 may display the pointer such that the closer a user motion is to the border of an angle scope within a predetermined scope near the angle scope of a camera, the higher the transparency of the pointer.

Further, when an input user motion goes beyond the motion recognition scope, the controller 140 may remove the pointer from the screen. For example, when a user motion goes beyond the angle scope of a camera, the controller 140 may remove the pointer from the screen.

Further, the controller 140 may change the motion speed of a pointer corresponding to a user motion according to the location where the pointer is displayed.

For example, when the pointer is located on the periphery of the screen, the controller 140 may reduce the motion speed of the pointer corresponding to the user motion. That is, even if a user hand moves the same distance, the distance moved by the pointer may be smaller at the border area than that at the center of the screen, because more accurate manipulation may be required to select an item at the border area of the screen. Particularly, if the pointer moves at the same speed at the border area of the screen as the pointer does at the center of the screen, it may be difficult for a user to select a corresponding item. Accordingly, when the pointer is located at a predetermined area near the border of the screen, the distance moved by the pointer may be reduced so as to allow a user to select an item accurately.

However, this is only one exemplary embodiment. According to one or more exemplary embodiments the distance moved by the pointer may vary in any area which requires accurate pointing other than the border area of the screen.

Particularly, depending on the characteristics of an item where a pointer is located, and depending on whether accurate pointing is required in the item, the distance moved by the pointer may vary.

Further, when the pointer moves into a predetermined scope with reference to the border line of the motion recognition scope, the controller 140 may change the speed of the pointer (for example, reduce the speed) and display the pointer. Herein, the predetermined scope may be different from the above-described scope of a recognition limit, although in accordance with another exemplary embodiment they may be the same depending on circumstances. Accordingly, feedback may be provided to a user in a similar manner as changing the display state of the pointer.

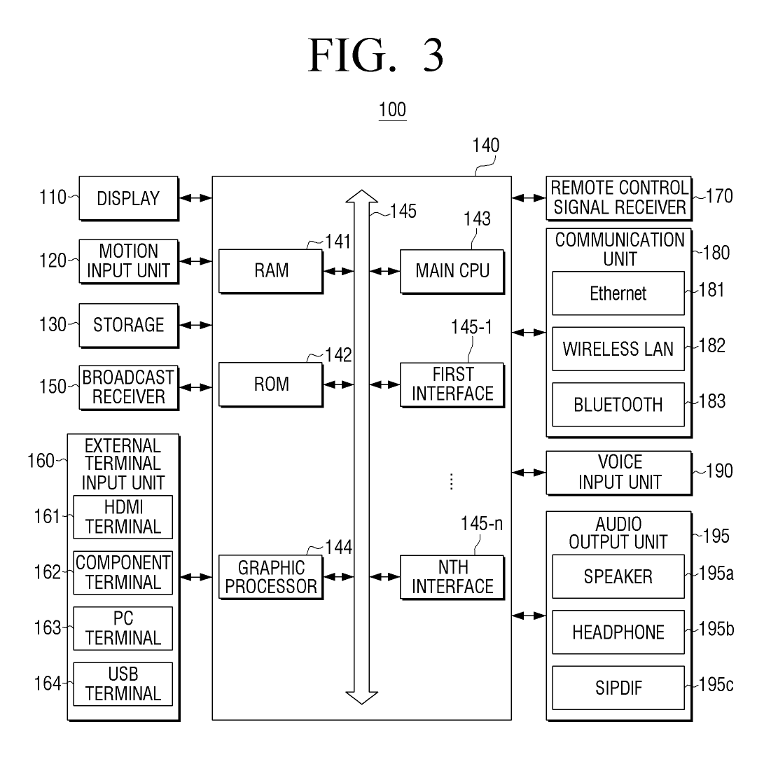

FIG. 3 is a block diagram illustrating a configuration of the electronic apparatus 100 according to another exemplary embodiment. Referring to FIG. 3, the electronic apparatus 100 includes at least a display 110, a motion input unit 120, a storage 130, a controller 140, a broadcast receiver 150, an external terminal input unit 160, a remote control signal receiver 170, a communication unit 180, a voice input unit 190, and an audio output unit 195.

In an effort to avoid an unnecessary duplicative explanation of similar elements, a detailed description regarding the components which are similar to those in FIG. 2 will not be provided.

The controller 140 includes a RAM 141, a ROM 142, a main CPU 143, a graphic processor 144, a first interface 145-1 through an nth interface 145-n, and a bus 146.

The RAM 141, the ROM 142, the main CPU 143, the graphic processor 144, and the first interface 145-1 through the nth interface 145-n may be communicably connected to each other through the bus 146.

The first interface 145-1 through the nth interface 145-n may be communicably connected to the above-described components. One of the interfaces may be network interface which is communicably connected to an external apparatus via a network.

The main CPU 143 accesses the storage 130 and performs a booting using an O/S stored in the storage 130. In addition, the main CPU 143 performs various operations using various programs, content, and data stored in the storage 130.

The ROM 142 stores a set of commands for system booting. If a turn-on command is input and power is supplied, the main CPU 143 copies an O/S stored in the storage 130 into the RAM 141 according to a command stored in the ROM 142, and executes the O/S to boot the system. Once the system booting is completed, the main CPU 143 copies various application programs stored in the storage 130 into the RAM 141 and performs various operations by executing the application programs copied in the RAM 141.

The graphic processor 144 generates a screen including various objects such as icon, image, text, etc. using an operator (not shown) and a renderer (not shown). The operator (not shown) calculates property values such as coordinates, shape, size, color, etc. of a screen where each object is displayed according to a layout of the screen. The renderer (not shown) generates a screen of various layouts including an object based on the property values calculated by the operator. The screen generated by the renderer (not shown) is displayed within a display area of the display 110.

The broadcast receiver 150 receives a broadcast signal from an outside source via cable or wirelessly. The broadcast signal may include video, audio and additional data (for example, EPG). The broadcast receiver 150 may receive a broadcast signal from various sources such as a terrestrial broadcast, a cable broadcast, a satellite broadcast, an Internet broadcast, etc.

The external terminal input unit 160 receives image data (e.g., video, photo, etc.), audio data (e.g., music, etc.), etc. from outside of the electronic apparatus 100. The external terminal input unit 160 may include at least one of High-Definition Multimedia Interface (HDMI) input terminal, component input terminal, PC input terminal, and USB input terminal. The remote control signal receiver 170 receives a remote control signal input from an external remote controller. The remote control signal receiver 170 may receive a remote control signal even when the electronic apparatus 100 is in an audio task mode or a motion task mode.

The communication unit 180 may connect the electronic apparatus 100 to an external apparatus (e.g., a server) under the control of the controller 140. The controller 140 may download an application from an external apparatus communicably connected through the communication unit 180 or perform web browsing. The communication unit 180 may provide at least one of Ethernet, wireless LAN 182, and Bluetooth.

The voice input unit 190 receives a voice signal uttered by a user. The voice input unit 190 converts the input voice signal into an electrical signal, and outputs it to the controller 140. In this case, the voice input unit 190 may be realized as a microphone. In addition, the voice input unit 190 may be provided integrally, in an all-in-one design, with the electronic apparatus 100 or separately from the electronic apparatus 100. The voice input unit 190, which is provided separately from the electronic apparatus 100, may be connected via cable or wireless network.

When a user voice signal is input from the voice input unit 190, the controller 140 recognizes the voice signal using a voice recognition module and voice database. Specifically, the controller 140 determines a voice section by detecting the beginning and end of a voice signal uttered by a user within an input voice signal, and generates phoneme data by detecting a phoneme which is the smallest unit of a voice, based on an acoustic model, in the voice signal within the detected voice section. The control unit 140 generates text information by applying a Hidden Markov Model (HMM) to the generated phoneme data. However, the above method of recognizing a user voice is only an exemplary embodiment, and a user voice signal can be recognized using other methods. Accordingly, the controller 140 may recognize a user voice included in a voice signal.

The audio output unit 195 outputs various audio signals under the control of the controller 140. The audio output unit 195 may include at least one of a speaker 195A, a headphone output terminal 195B, and a Sony/Philips Digital InterFace (S/PDIF) output terminal 195C.

In particular, when a user motion is input within the scope of a recognition limit which is predetermined to be an area within the border line of the motion recognition scope through the motion input unit 120, the audio output unit 195 may output an alarm sound under the control of the controller 140. Accordingly, a user may be provided with an audio feedback warning of the case where a user motion goes beyond the motion recognition scope.

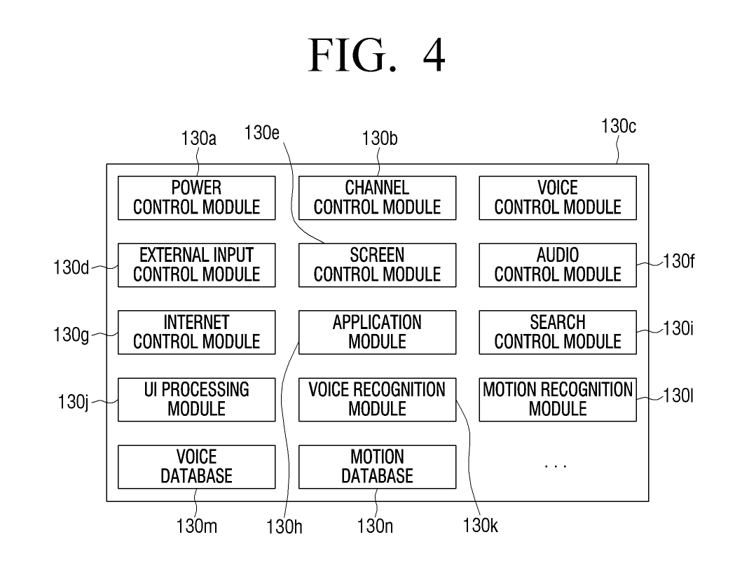

FIG. 4 is a block diagram illustrating a configuration of software stored in a storage according to an exemplary embodiment.

As illustrated in FIG. 4, the storage 130, i.e., memory includes a power control module 130A, a channel control module 130B, a volume control module 130C, an external input control module 130D, a screen control module 130E, an audio control module 130F, an Internet control module 130G, an application module 130H, a search control module 130I, a UI processing module 130J, a voice recognition module 130K, a motion recognition module 130L, a voice database 130M, and a motion database 130N. Each of the modules 130A through 130N may be realized as software able to perform a power control function, a channel control function, a volume control function, an external input control function, a screen control function, an audio control function, an Internet control function, an application execution function, a search control function, and a UI processing function. The controller 140 may perform the corresponding functions by executing the software stored in the storage 130. For example, the controller 140 may recognize a user motion using the motion recognition module 130L and the motion database 130N.

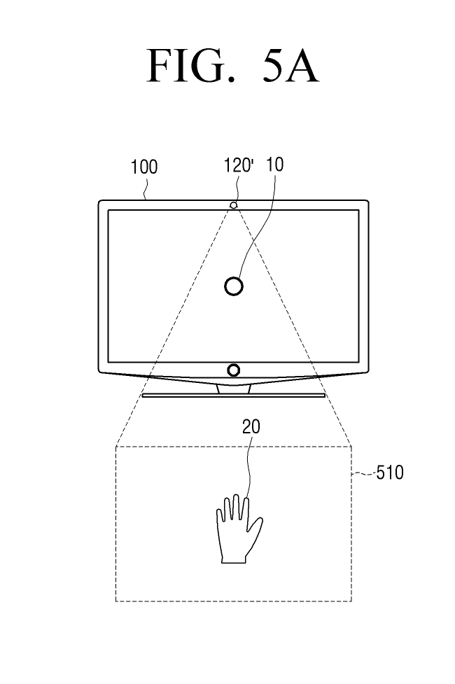

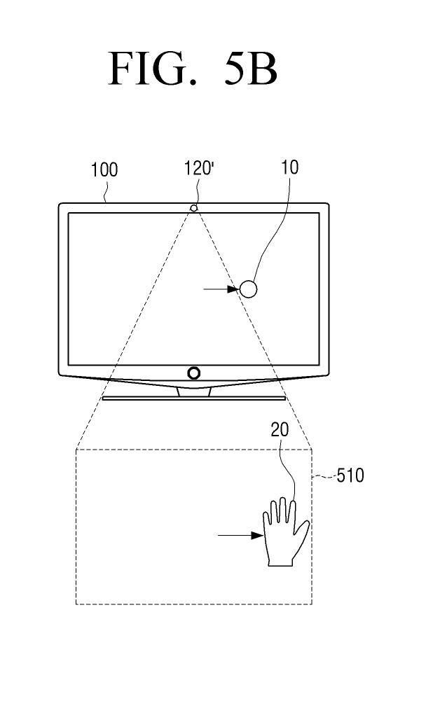

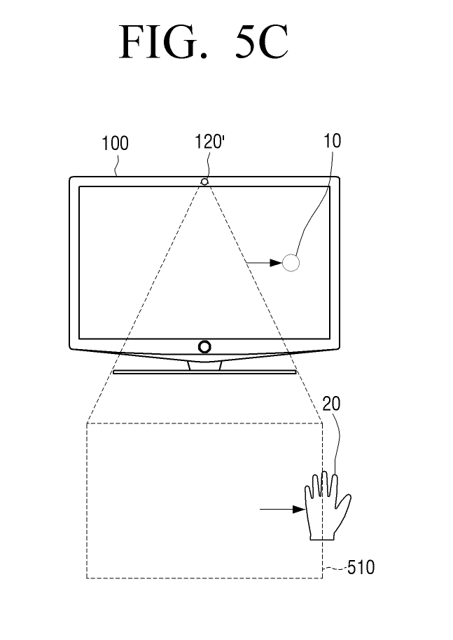

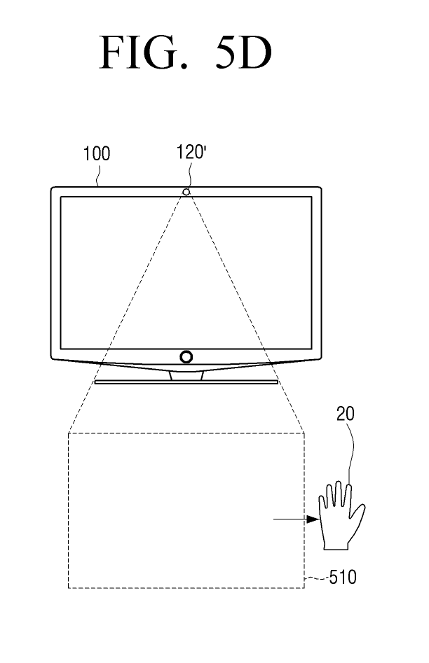

The method for providing a UI according to various exemplary embodiments will be explained with reference to FIGS. 5 to 7.

FIGS. 5A through 5D are views illustrating a method for providing a UI according to an exemplary embodiment.

According to the upper portion of FIG. 5A, when a motion task mode is activated according to a predetermined event, the pointer 10, which is controlled by a motion, may be displayed.

In this case, as illustrated in the lower portion of FIG. 5A, a user hand 20 which controls the motion of the pointer 10 may be recognized within an angle scope 510 of a camera, that is, a motion recognition scope.

Subsequently, when the user hand 20 is moved to the right side, as shown in the lower portion of FIG. 5B, the location of the pointer 10 displayed on the screen may be moved based on the direction and distance the user hand 20 is moved as illustrated in the upper portion of FIG. 5B. In this case, the closer the user hand 20 gets to the border of the angle scope 510 of a camera, the higher the transparency of the pointer 10.

In addition, as illustrated in the lower portion of FIG. 5C, when the user hand 20 moves closer to the angle scope 510 of a camera or moves beyond the angle scope 510 partially, the transparency of the pointer 10 may be further increased as illustrated in the upper portion of FIG. 5C.

Further, as illustrated in the lower right portion of FIG. 5D, when the user hand 20 moves beyond the angle scope 510 of a camera completely; the pointer 10 may be removed from the screen.

Accordingly, a user may recognize the spatial location of their gestures within the sensor recognition scope before his or her motion gets out of the sensor recognition scope.

In the above exemplary embodiment, the transparency of the pointer displayed on the screen changes according to the motion recognition scope, but this is only an example. In another exemplary embodiment, at least one of the color or shape of the pointer may be changed.

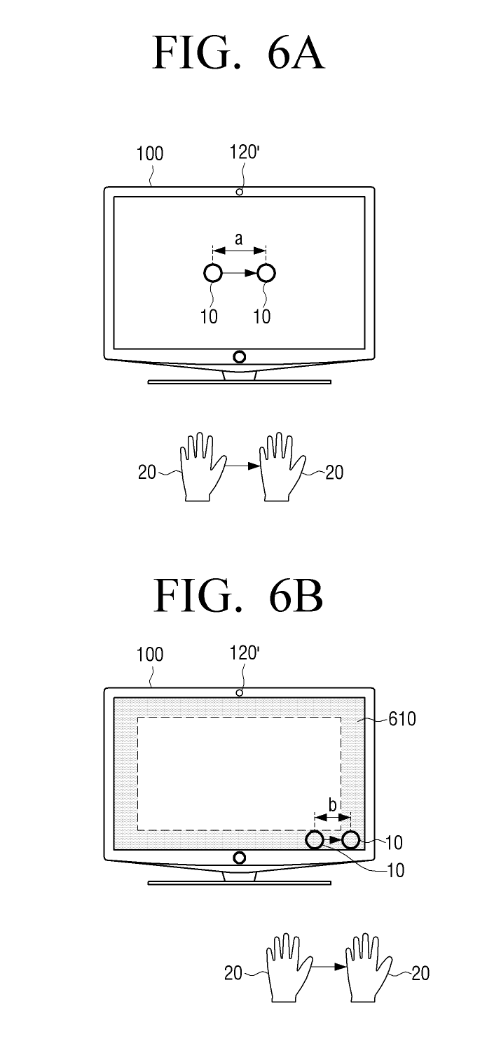

FIGS. 6A and 6B are views illustrating a method for providing a UI according to another exemplary embodiment.

As illustrated in FIG. 6A, when the pointer 10 is displayed at the center of the screen, it is assumed that the pointer 10 moves as much as the distance of ‘a’ according to the distance the user hand 20 is moved.

Subsequently, as illustrated in FIG. 6B, when the pointer 10 is displayed at the peripheral area 610 of a predetermined screen, even if the distance moved by the user hand 20 is the same as the distance illustrated in FIG. 6B, which is the same distance as shown in FIG. 6A, the pointer 10 may move only as far as ‘b’ which is smaller than ‘a’.

That is, depending on the location where the pointer 10 is displayed on the screen, the speed of the pointer 10 and the distance moved by the pointer 10 according to the same user motion may vary.

The above function is provided to allow a user to perform a pointing manipulation more accurately when selecting an item on the peripheral area of the screen by reducing the motion speed of the pointer.

Meanwhile, in the above exemplary embodiment, the motion speed of the pointer is changed on the peripheral area of the screen, but this is only an example. The above feature may be applied to any area which requires a user's accurate pointing manipulation. For example, the motion speed of the pointer may also be reduced when an accurate point manipulation is required in a specific item at the center of the screen.

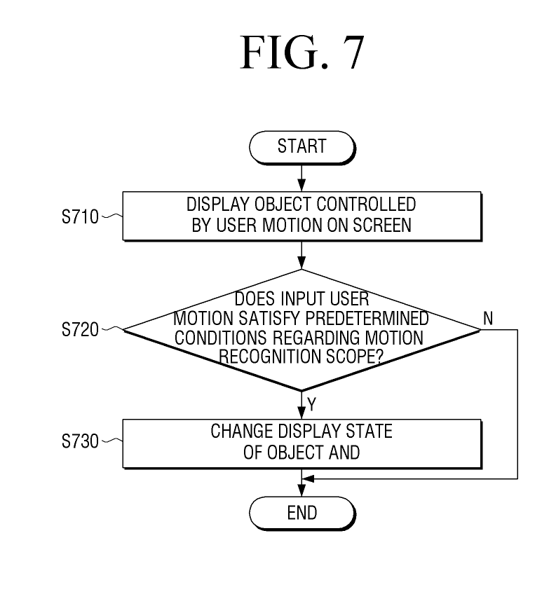

FIG. 7 is a flowchart provided to explain a method for controlling an electronic apparatus according to another exemplary embodiment.

According to the method for controlling an electronic apparatus illustrated in FIG. 7, an object controlled by a user motion is displayed on the screen (S710).

Subsequently, it is determined whether the input user motion satisfies a predetermined condition regarding a motion recognition scope (S720). Herein, the motion recognition scope may be a photographing scope which is determined by an angle of a camera photographing a user motion.

When the input user motion satisfies a predetermined condition with respect to a motion recognition scope (S720:Y), the display state of the object may be changed and displayed (S730).

In operation S730, the display state of the object displayed on the screen is changed and displayed, in response to the input user motion entering an area within the scope of a recognition limit which is predetermined to be an area inside the motion recognition scope that requires a change in the properties of that which is displayed. In a specific example this determination occurs when the user motion approaches the border of the scope, thereby triggering at least one of the color, transparency, and shape of the object being changed and displayed.

In operation S730, the display state of the object displayed on the screen is changed and displayed. Specifically, the transparency of the pointer may be increased and displayed in response to the input user motion moving closer in a direction of the border of a motion recognition scope within the scope of a recognition limit.

Further, if the input user motion goes beyond the motion recognition scope, the object may disappear from the screen.

In addition, when an object moves within a predetermined scope with reference to the border of the motion recognition scope by a user motion, the speed of the object may be changed and displayed. In this case, the motion speed of the object may be reduced and displayed within a predetermined scope with reference to the border of the motion recognition scope.

Further, when a user motion is input within the scope of a recognition limit which is predetermined to be an area inside the motion recognition scope with reference to the border line of the motion recognition scope, an alarm sound may sound.

As described above, the exemplary embodiment may prevent the inconvenience which occurs due to the limitation of a sensor that recognizes the location of a user manipulation and the manipulation result on separate screens.

The method for controlling an electronic apparatus according to various exemplary embodiments may be realized as a program and provided in an electronic apparatus.

For example, a non-transitory computer readable medium storing a program which displays an object controlled by a user motion that changes and displays the display state of the object in response to the input user motion satisfying a predetermined condition with respect to a motion recognition scope, may be provided.

Herein, the non-transitory recordable medium refers to a medium which may store data semi-permanently rather than storing data for a short time such as a register, a cache, and a memory and may be readable by an apparatus. Specifically, the above-mentioned various applications or programs may be stored in a non-temporal recordable medium such as CD, DVD, hard disk, Blu-ray disk, USB, memory card, and ROM and provided therein.

The foregoing exemplary embodiments and advantages are merely exemplary and are not to be construed as limiting the present invention. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An electronic apparatus comprising:
a motion input unit configured to receive a user motion;
a display configured to display an object controlled by the user motion received by the motion input unit; and
a controller configured to change a display state of the object in response to the input user motion satisfying a predetermined condition with respect to a motion recognition scope.

2. The electronic apparatus as claimed in claim 1,
wherein the controller is further configured to change at least one of a color, a transparency, and a shape of the object displayed by the display in response to the user motion entering into an area within a scope of a recognition limit,
wherein the area is further configured to be predetermined to be inside the motion recognition scope with respect to a border of the motion recognition scope.

3. The electronic apparatus as claimed in claim 2, wherein the controller is further configured increase a transparency of the object displayed by the display in response to the input user motion moving in a direction closer to the border of the motion recognition scope within the scope of the recognition limit.

4. The electronic apparatus as claimed in claim 1, wherein the controller is further configured to remove the object from being displayed by the display in response to the input user motion going beyond the motion recognition scope.

5. The electronic apparatus as claimed in claim 1, further comprising:
an audio output unit,
wherein the controller is further configured to control the audio output unit to output an alarm sound in response to the user motion being within a scope of a recognition limit which is predetermined to be an area inside the motion recognition scope.

6. The electronic apparatus as claimed in claim 1, wherein the controller is further configured to change a motion speed of the object displayed by the display in response to the object moving in a predetermined area of the display according to the user motion.

7. The electronic apparatus as claimed in claim 6, wherein the controller is further configured to decrease the motion speed of the object displayed by the display at a predetermined peripheral area of the display.

8. The electronic apparatus as claimed in claim 1, wherein the motion input unit comprises a camera photographing the user motion,
wherein the motion recognition scope of the motion input unit is changed according to an angle of the camera.

9. A method for controlling an electronic apparatus, the method comprising:
displaying an object controlled by a user motion on a display; and
changing a display state of the object displayed on the display in response to the user motion satisfying a predetermined spatial condition with respect to a motion recognition scope.

10. The method as claimed in claim 9, wherein the changing the display state and the object comprises changing at least one of a color, a transparency, and a shape of the object displayed on the display in response to the user motion entering into an area within a scope of recognition limit which is predetermined to be an area inside the motion recognition scope with respect to a border of the motion recognition scope.

11. The method as claimed in claim 10, wherein the changing the display state and the object comprises increasing a transparency of the object displayed on the display in response to the input user motion moving in a direction closer to a border of the motion recognition scope within the scope of a recognition limit.

12. The method as claimed in claim 9, further comprising:
removing the object from being displayed on the display in response to the user motion going beyond the motion recognition scope.

13. The method as claimed in claim 9, further comprising:
outputting an alarm sound in response to the user motion being input within a scope of a recognition limit which is predetermined to be an area inside the motion recognition scope.

14. The method as claimed in claim 9, further comprising:
changing a motion speed of the object displayed on the display in response to the object moving in a predetermined area of the display according to the user motion.

15. The method as claimed in claim 14, wherein the changing the motion speed of the object comprising decreasing the motion speed of the object displayed on the display at a predetermined peripheral area of the display.

16. A method of controlling an electronic apparatus, the method comprising:
receiving a user motion input at the electronic apparatus,
determining a spatial location of the user motion input within a motion recognition area; and
configuring a display state of a pointer to be displayed by the electronic apparatus in response to the spatial location being within a predetermined area of the motion recognition area,
wherein the display state is configured to adjust at least one of a color, a transparency, a shape, and a movement speed of the pointer when displayed.

17. The method of controlling an electronic apparatus of claim 16, wherein the configuring of the display state further comprises:
configuring the display state such that the transparency of the pointer is increased and the movement speed of the pointer is decreased in response to the user motion having at least one of the spatial location that is near an outer border of the motion recognition area and a spatial trajectory towards the outer border.

18. An electronic apparatus comprising:
a receiver configured to receive a user motion input, and
a controller configured to determine a spatial location of the user motion input within a motion recognition area,
wherein the controller is further configured to adjust a display state of a pointer to be displayed by the electronic apparatus in response to the spatial location being within a predetermined area of the motion recognition area, and wherein the display state is configured to adjust at least one of a color, a transparency, a shape, and a movement speed of the pointer when displayed.

19. The electronic apparatus of claim 18, wherein the controller is further configured to adjust the display state such that the transparency of the pointer is increased and the movement speed of the pointer is decreased in response to the user motion having at least one of the spatial location that is near an outer border of the motion recognition area and a spatial trajectory towards the outer border.
